(19) United States
(12) Patent Application Publication
(10) Pub. No.: US 2007/0029307 A1
(43) Pub. Date: Feb. 8, 2007

(54) Electrically conductive coatings and method of their use

(75) Inventor: Stephen F. Erickson, Sparks, NV (US)

Correspondence Address: PEARNE & GORDON LLP, 1801 EAST 9TH STREET, SUITE 1200, CLEVELAND, OH, 44114-3108, US

(73) Assignee: Progressive Coatings Technologies, Inc.

(21) Appl. No.: 11/184,518

(22) Filed: Jul. 19, 2005

(51) Int. Cl. H05B 3/16

(52) U.S. Cl. 219/543

(57) ABSTRACT

It has been discovered that finely ground elemental graphite enhances the electrical conductivity of a coating when added to conductive amorphous carbon, using any one of several different binders in formulating the coating. The coating can be energized with electrical energy creating an electrical resistance heat element. Such combination of amorphous carbon and elemental graphite particles, ranging in size from about 0.001 to less than 1 micron, creates a more uniform conductive coating compared to use of larger sized particles, where the amount of conductive particles ranges from about 5 to about 80 weight-% based on the non-volatile solids content of the coating formulation (e.g., without solvent and other components that evolve (are driven off) from the coating during drying).

### CROSS-REFERENCE TO RELATED APPLICATIONS

None

### STATEMENT REGARDING FEDERALLY SPONSORED RESEARCH

Not applicable.

### BACKGROUND OF THE INVENTION

The present invention relates to coatings that are able to generate heat and, more particularly, to an electrothermic coating that utilizes non-metallic particles of carbon and graphite for achieving heating characteristics. Additionally, the coating can be used, inter alia, as a ground plane, electromagnetic shield, or Gaussian Cage when properly grounded.

The present investigation started as an attempt to replicate the work of Miller (U.S. Pat. No. 6,086,791) to make prototype applications. It was found that higher concentrations of much smaller particle sized carbon and graphite particles produced a more conductive (lower resistivity) coating and more predictive results. The carbon and graphite were both well below the 5-micron size particles lower limit in the Miller patent, being about 0.03 microns average particle size. It also was determined that the instability of the coating was not “running away when energized”, but was caused by the resistance lowering as the volatile solvent was driven off during heating of the coating. The stability of the coating was greatly improved when heating the coating, i.e., electrically energizing the coating, in a controlled manner to drive off the volatile solvents. The dried coating initially was not very durable as solvent easily destroyed it. However, the heated coatings were next to indestructible (i.e., solvent resistant) after the solvent was driven out of the coating.

The present investigation has evolved into a simpler process for making the coating comprised of smaller particle sizes of larger quantities of carbon and graphite, resulting in a well defined domain of carbon and graphite mixes that work for more conductive/less resistive coatings, and solving the stability and reproducibility of the art of creating an electrically conductive coating that can be used to make heating elements, ground planes, and Gaussian Cages, to name a few uses.

Heretofore, Miller (U.S. Pat. No. 6,086,791) proposes that different carbon components are required in an electrically conductive exothermic coating consisting of flake-like carbon and graphite of particle size between about 5 and 500 microns with promising results. It also claims that the coating can be made self-regulating by adding non-conductive flake like pigment.

Miller (U.S. Pat. No. 6,818,156) also proposes to use a binder, an electrically conductive carbon black particle generated by high temperature pyrolysis of acetylene electrically conductive graphite and having a particle size between of between 5 and 500 μm and 10 and 75 weight-% based on the non-volatile solids content of the coating composition.

### BRIEF SUMMARY OF THE INVENTION

The present invention is based on the discovery that different carbon components characterized as being much smaller in size and used in a greater quantity than heretofore proposed in the art, creates an electrically conductive coating with commercially viable resistance heating characteristics. It also was discovered that the stability of the coating, made from two different carbon components, is related to the quantity of volatile compounds (e.g., volatile or fugative solvent) adsorbed by the carbon. When such volatile compounds are removed, a durable, stable electrically conductive coating results. Stability of the coating and durability of the coating is achieved by its heating to an elevated temperature sufficiently high to drive off the solvent(s) used in formulating the coating.

It also has been discovered that finely ground elemental graphite enhances the electrical conductivity of the coating when added to conductive amorphous carbon, using any one of several different binders in formulating the coating. The coating can be energized with electrical energy creating an electrical resistance heat element. Such combination of amorphous carbon and elemental graphite particles ranging in size from about 0.001 to less than 1 micron creates a more uniform conductive coating compared to the use of larger sized particles, where the amount of carbon and graphite particles ranges from about 5 to about 80 weight-% based on the non-volatile solids content of the coating formulation (e.g., without solvent and other components that evolve (are driven off) from the coating during drying). The different combinations of carbon and graphite added to the binder can control the resistivity, conductivity, and durability of the coating. The coating is very stable and durable within the temperature limitations of the binder (e.g., silicone resin can be stabile up to about 1300° F. and ceramic parts can be stable up to about 2000° F.) and other system components (e.g., adhesive for electrical leads can be stable up to only about 350° F.) used to formulate the coating and system for a particular use or application, once the volatile components are driven out of the coating.

The novel coating can be made by initially forming a blend of amorphous carbon and elemental graphite by weighing out the agents and then mixing in a blender. The mix then is added to a standard sample of binder and solvent, and blended with a mixer in a sample can. Additional solvent is added as necessary, desirable, or convenient to achieve application viscosity, for example, to make a sprayable coating. The can then is sealed and set-aside until needed, for example, to spray on test tiles or other applications.

The binder used, then, should be able to withstand the expected temperatures of the coating and, thus, may be temperature resistant silicone resins, polyamide resins, bis-maleimide resins, concrete, ceramics, and the like depending on the application.

Advantages of the present invention include the ability to generate elevated temperatures, which is a function of the binder, substrate, electrical components, and the like. The test sample temperature range was limited by the copper leads and tiles used. The temperature limit for copper leads was about 350 degrees Fahrenheit (° F.) due to the self adhesive on the copper. The ceramic tiles broke at about 400° F. The binder reported in the examples was rated at 1300° F. and was not a limitation; however, several test samples failed when there was a scratch in the coating or break or in the contact with the copper leads. Electrical arcing at about 2,000 to 2,500° F. caused the binder to incinerate.

Another success was the ability to produce a stable electrically conductive coating. Some forms of carbon have the property of holding onto volatile organic compounds, such as solvents, even when the coating appears dry. Several tests were conducted to track the long-term drying of the coating and the continued lowering of the resistance of the test samples. Additionally, tests were conducted that showed the impact heating had on the lowering of the resistance of samples. With lower resistance, a sample heated faster but reached the same equilibrium state, where the test tile was first heated, cooled off, and reheated, (e.g., equilibrium is the balancing of energy in equal with energy lost, when the tile was cooling off at the same rate as the energy being added to a given thermal mass and the environment.) However, continued heating also caused even more solvent to be driven off at the lower temperatures (less than 400° F.) and, thus, lowered the resistance further, but to a lesser extent. The result is the knowledge that samples must be heated to the point that all the solvent is driven out of the coating to produce a stable coating with a constant resistance. Results showed that a heated sample's resistance dropped to about 55% of the air-dried sample's resistance.

It also was determined that the self-limiting nature of the coating is directly related the equilibrium set up between the energy balance of energy in versus energy out (a function of thermal mass, surface area, and environment).

A further advantage is that the inventive coating maintains its coating properties and can be applied by brush, roller coat, reverse roller coat, spray, and the like. As the painting process improves, robotic machines will be able apply the coating in varying thicknesses in a 3-dimensional application. These and other advantages will be readily apparent to those skilled in this art.

### DETAILED DESCRIPTION OF THE INVENTION

Carbon Forms

The understanding of carbon and its multiple allotropes is critical to understanding various attempts to create a conductive coating. Allotropes are different physical forms of the same element, such as a hard, highly structured crystal and a soft, less-structured substance. Allotropes differ in the way the atoms bond with each other and arrange themselves into a structure. Because of their different structures, allotropes have different physical and chemical properties. The three most common allotropes of carbon are diamond, graphite, and amorphous carbon. The fullerene forms of carbon are a recent discovery (1985) and have been used in several processes to create a conductive coating, paste, or the like with limited success.

In a diamond, each carbon atom bonds tetrahedrally to four other carbon atoms to form a three-dimensional lattice. Pure diamond is an electrical insulator-it does not conduct electric current.

Graphite is black and slippery, and conducts electricity. In graphite, the atoms form planar, or flat, layers, or flake-like structure. Graphite conducts electricity, because the electrons in the Tr-bond system can move around throughout the graphite. It is one of the two active ingredients in this coating.

Amorphous carbon is actually made up of tiny crystal-like bits of graphite with varying amounts of other elements, which are considered impurities. The amorphous carbon used for coatings is carbon black and also is known as acetylene black, channel black, furnace black, lamp black, lampblack, thermal black, and noir de carbone. Carbon Black has been assigned Chemical Abstracts Service (CAS) Registry Number 1333-86-4 and is the primary active ingredient in the inventive coating. This number is assigned by the CAS in the United States and is used as a unique identifier number worldwide. Other examples of amorphous carbon include charcoal and the coal-derived fuel called coke. Average particle diameters in several commercially-produced carbon blacks range from about 0.01 to about 0.4 micrometers (μm), while average aggregate diameters range from about 0.1 to about 0.8 μm. Most types of carbon black contain over 97% to 99% elemental carbon.

In 1985 chemists created a new allotrope of carbon by heating graphite to extremely high temperatures. They named the allotrope “buckminsterfullerene” (see http://encarta.msn.com/encyclopedia 761579900/Buckminsterfullerene.html), after American architect R. Buckminster Fuller. Fuller designed geodesic domes, rigid structures with a three-dimensional geometry that resemble this form of carbon. Unlike diamond and graphite that can have an unending crystal structure, the original fullerene formed molecules of 60 carbon atoms (with a molecular formula of C₆₀ and are called “buckyballs”). Scientists have since discovered other fullerenes, including very narrow, long tubes and the C₇₀ fullerene, an elongated structure shaped more like a football but rounded on the ends. After scientists discovered fullerenes in the lab, geologists discovered fullerenes in nature—in ancient rocks in New Zealand and in the meteorite-created Ries Crater in Germany (see http://encarta.msn.com/encyclopedia 761571891/Meteorite.html). Others have used the fullerene forms of carbon in patents with apparent varying degrees of success.

It has been discovered further that there is a significant range of amorphous carbon and elemental graphite mixes that will produce stable conductive coatings. Such combination of amorphous carbon and elemental graphite in particles sizes of about 0.001 to less than 1 micron should be used to create a stable uniform electrically conductive coating. The amount of such pigments should range from about 5 to about 80 weight-% based on the non-volatile solids content of the coating formulation (e.g., without solvent and other components that evolve from the coating during drying and curing operations).

Amorphous carbon in the mix above a certain amount (about 5% g/ml of binder), conductivity improved with increasing amounts of amorphous carbon only. However, at a certain point (about 10% g/ml of binder), the solvent adsorbed by the carbon creates an unstable coating and becomes the effective limit of carbon in the mix.

It also has been discovered that the conductivity of the coating is increased with the addition of elemental graphite (up to about 30% g/ml of binder) to the amorphous carbon in the mix. Elemental graphite alone did not produce a conductive coating in the concentrations tested, but did enhance the conductivity of the mix when added to the carbon/binder mix. There is a concentration of graphite where the binder cannot hold any more in suspension and the graphite drops out of suspension during the spraying process; thus, determining the upper limit of graphite in the mix. Different manufacturing processes will change this upper limit, as more graphite will stay in suspension (e.g., if constantly agitated. However, the marginal improvement in conductivity may not be worth the cost.)

One of the most important findings uncovered during the course of research on the present invention was that the particle size of the carbon and graphite needed to be significantly smaller than that reported by Miller, supra. The carbon and graphite that is commercially available appeared to be formed of agglomerates, perhaps for ease in handling by the manufacturer. At such large particles sizes, reported by the art as between 5 and 500 μ, the performance of the coatings was not as reproducible. When such carbon and graphite material was de-agglomerated, however, electrical performance (resistance or conductivity) stabilized and the results were quite reproducible. This present invention, then, discloses that the carbon and graphite need to be in the sub-micron size to create effective, reproducible, and commercially viable coatings. Whipping the dry carbon and graphite components in a stainless steel commercial blender and sealing the lid with tape to keep the fine particles confined in the blender creates the needed smaller particle sizes. Initially, the blender was turned on at top speed for two minutes to break up the large agglomerates of carbon. The larger granular particles of carbon provided by the vender for easy handling and shipping, were reduced to fine particles, like the carbon black from incomplete combustion that is released when a rubber tire is burned and seen floating through the air. The resultant mix expanded in volume by about 15 times the original volume of the mix. Graphite did not change volume when mixed alone but when mixed with carbon, created a very homogeneous mix.

The inventive paint is unique in its ability to function as a heating element or an electrically conductive coating that can be used as a ground plane or Gaussian Cage. Uses include, but are not limited to, hot water heating elements, steam table heating elements, humidifier heating elements, grill heating elements, and deicing heating elements for sidewalks, driveways, roads, vehicles, equipment, helicopter blades, airplane wing deicing elements. Home/commercial appliances include: tankless water heaters, hot water tanks, dishwasher heating elements dishwater drying elements, bath tubs, hot tubs, dryers, irons, clothes presses, space heaters, cooking surfaces such as stoves, hot plates, woks, toasters, water heaters, coffee makers, furnaces, hot tubes, commercial/industrial/home ovens, etc., medical equipment, as a replacement for resistant heating devices, oilfield heating elements on oil tanks, pipes, pumps and the like. Manufacturing processes that need heat can have the “tools” heated directly instead of using an oven to cure parts. The foregoing list is merely illustrative and a wide variety of uses that will become apparent based on the disclosure set forth herein.

The present invention relies on non-metallic, electrically conductive, amorphous carbon and elemental graphite for obtaining heat from the coating. The amorphous carbon and elemental graphite pigments should range in particle size from between about 0.001 and less than 1 micron with the average particle size of about 0.03 microns, and can be present in as little as about 5 wt-%, on up to about 80 wt-% based on the non-volatile solids content of the coating formulation (e.g., without solvent and other components that evolve (are driven off) from the coating during drying). Typically, the more amorphous carbon pigment present, the more conductive the coating. With only graphite present (i.e., no amorphous carbon), the coating was not conductive within the range tested; but when amorphous carbon was added to the graphite, conductivity of the coating resulted. Coatings have been produced that generate 100 watts per square inch of coating.

Since the coating generates such high quantities of heat, the other system components, including the binder used, must be able to withstand such elevated temperatures. Thus, heat-stable resins should be used including, for example, acrylics, alkyds, cellulosics, epoxies, fluoro-plastics, ionomers, natural rubber, nylons, phenolics, polyamides, polybutadiene, polyesters, polyimides, polypropylene, polyurethanes, silicone resins, silicone rubber, styrene-butadiene; nitrile rubber, polysulphide rubber, vinyl-ethylene, polyvinyl acetate, silicates and polysilicates; hydraulic setting Portland cement, sodium aluminate and gypsum (Plaster of Paris); glass compositions, including glass fruits; ceramic and refractory compositions; and minerals, such as bentonites, and the like. Of importance is that the resin has the ability to withstand elevated temperatures without loss of integrity of the coating and the desired (or required) coating properties. Those skilled in the resin art will readily be able to provide a wide variety of such temperature-stable resins. See, for example, Solomon, The Chemistry of Organic Film Formers, Robert E. Krieger Publishing Company, Huntington, N. Y. (1977), the disclosure of which is expressly incorporated herein by reference.

The inventive paint can be applied to a substrate by direct roll coat or curtain coating with or without a knife, reverse roller coat, atomized application, or like conventional techniques. Cure of the coating can be by applying electricity to heat the coating or it can involve baking at a temperature and for a time for driving out the solvent of the system employed, solvents used, and like factors well known to those in the coatings field.

Laws of Physics

As an electrically conductive resistance element, the coating follows conventional electrical engineering laws. The value of coating resistance can be calculated as follows:

Assumption: The coating material has a uniform homogeneous composition.

Variables:

R_{T}=is the total Resistance measured for the whole coating.

R_{X}=is the resistance per length of lead

R_{Y}=is the resistance per inch between the leads

R_{Z}=is the resistance per inch of thickness throughout the coating material

L=is the length of lead

D=is the distance between the leads

H=is the thickness of the coating
First:
   Divide the coating along the length of the copper leads into a series of parallel resistance devices.
   So: 1/R_{T}=1/R₁+1/R₂+1/R₃. . . . +1/R_{L}
   where: L is the length of lead in inches
   So, R_{X}=L×Rₜ, and is the resistance per inch of lead.
Second:
   The distance between the leads acts as a series resistances, or:
   R_{X}=R₁+R₂+R₃. . . . +R_{D},
   where: D is distance between the leading edges of the leads in inches.
   So: R_{X}=D*R_{Y} and is the resistance per square inch between leads.
   Substituting for the R_{X}, we have:
   R_{Y}=L×R_{T}/D
   where: R_{Y} represents the resistance in ohms per square inch of coating.
Third:
   The thickness of the coating represents parallel resistances, so that:
   R_{Z}=H*R_{Y}
   where: H is the thickness of the coating.
   Substituting for R_{Y}, we have:
   R_{Z}=H*L*R_{T}/D
   where: R_{Z} is a constant for each design mix.

The actual measured values vary from the air-dried samples and cured sample by about 55%. Therefore, the estimated cured value, R_{ZC}, should be used for actual design calculations. The foregoing calculations are the derivation of the formulas used in the design calculations in the following examples.

While the invention has been described with reference to a preferred embodiment, those skilled in the art will understand that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In this application all units are in the metric system and all amounts and percentages are by weight, unless otherwise expressly indicated. Also, all citations referred herein are expressly incorporated herein by reference. The following examples show how the present invention can be practiced. They should be construed as illustrative of the invention and not a limitation of it.

### IN THE EXAMPLES

The following general procedure was used in making the formulations reported in the examples:

Amorphous carbon and natural graphite mixtures were prepared as follows:

1. Material was weighed out to the tenth of a gram.

2. Material was placed in commercial blender and the top sealed with duct tape.

3. Material was then mixed for 2 minutes in the sealed container.

4. Mixture was then poured into a 1-quart paint can with the use of a large funnel.

5. 300 ml of binder and various amounts of solvent then were added to the can.

6. Material then was mixed with a hand blender in the one-quart paint can for about 2 minutes.

7. Mixture was sealed in the can and set aside until ready to use.

8. When ready to paint, the mixture was tested with a #2 Zahn cup for viscosity and the mixture as adjusted with more xylene to get a flow rate of about 30 seconds.

9. Mixture was added to the spray gun reservoir can and was ready to apply.

The electrically conductive coating then was formed as follows:

1. Prepare the substrate with a non-electrically conductive coating or substrate. Some of the sample pans were purchased with an enamel coating. Other samples were coated with three coats of appliance white powered coating.

2. Apply two copper foils with self-adhesive backing as electrodes (0.5 in. wide×2 mil thick×desired length) to substrate to be coated, parallel to each other along opposite edges of the surface to receive the coating.

3. Clean and dry the surface to be coated.

4. Mask the surface of the substrate to be coated such that the electrodes and the area between the electrodes will be able to receive the coating. Be sure to mask the ends of the electrodes so that the copper foil is available to solder wire leads to be connected to a power source.

5. Apply multiple layers of the design mix using a conventional air spray gun to achieve the desired total resistance of the dried and cured coating. Allow about 30 minutes drying time between each layer. Upon completing the coating process, allow the coating to dry overnight to avoid blistering when curing.

6. Solder electrical wire leads to the ends of the copper electrodes. Connect the leads to a variable electrical source (0-120 volts ac @ 1-15 amps). Cure the sample by slowly increasing the temperature of the coating to drive out the solvent that has been adsorbed by the carbon. The coating should be heated to above 400° F. or higher to completely drive out the solvent. The temperature limitation is based on the self-adhesive. Be careful not to dry out the sample too fast as the coating may blister.

7. Hook up the thermostatic controls to the sample and test the device. Measure the total resistance of the sample and test.

The following ingredients were used in compounding the formulations tested:

Printex XE-2 Carbon A highly conductive carbon black pigment, Pigment MW of 12, flake-like structure, Particle size 35-micron max, Iodine Absorption, 1078 gm/g, MSDS #1746 01-63, Degussa Corporation

Printex L6 Carbon A semi-conductive carbon pigment, MW of 12,Pigment flake-like structure, 1,000-1,500 μM grind level, MSDS #1019, Degussa Corporation

Graphite Pigment Purified natural graphite, 99.8% carbon content, 0.2% ash level, 125-mesh grind level, 325 mesh (US) particle size, MSDS #2935K, Superior Graphite Co.

Silicone Resin “Flame Control” Kem Hi-Tem Coating, No. 850 Series, MSDS #7.06b, high temperature rating (>850° F.), silicone alkyd resin reduced in xylene, Sherwin Williams Co.

L-1062-1 Industrial Heat Resistant Coating Flame Control Coating, Inc.

Dow Corning 805 Silicone Resin MSDS # 0289937, performs up to 538 degrees C. (1000° F.), silanol-functional resin, reduced in xylene and ethybenzene, Dow Corning Corporation

### Example 1

### Fry Pan

A coating was compounded from the following ingredients:

TABLE 1

| Ingredient | Amount (g) |
|---|---|
| Graphite 2935K pigment | 50 |
| Printex X2 carbon pigment | 25 |
| 850 Flame Control silicone resin | 300 |
| Xylene | 400 |

A NORDICWARE High Side Texas Grille was coated with 6 coats of the design mix on top of and between 0.5 inch copper leads set 7.775 inches apart and 8 inches long. Running electricity through the coating with water in the pan cured the coating in the pan. The cured heating element (coating) total resistance was lower that the desired 8 ohms, because of the unknown nature of the curing process. The coating was sanded with a 400-grit paper to remove some of the cured coating, which increased the total resistance to 8 ohms. The cured coating, then, was coated with a clear binder to act as an electrically non-conductive coating. When 120 volts was applied, 1800 watts were generated at 15 amps. This power boiled 1 inch of water in about 4 minutes in the open pan.

### Example 2

### Steam Table Humidifier

A coating was compounded from the following ingredients

TABLE 2

| Ingredient | Amount (g) |
|---|---|
| Graphite 2935K pigment | 50 |
| Printex L6 carbon pigment | 20 |
| 850 Flame Control silicone resin | 300 |
| Xylene | 400 |

A stainless steel pan 6×12×18 inches was coated as in Example 1 with 5 layers of paint in a 3.125-inch square area replicating the 700-watt heating element used to generate steam for heating food in a food service holding box. The pan was filled with 4 inches of water and energized with 120 volts of electricity. The total resistance of the heating element was about 20 ohms, which was able to boil the water when the pan was covered. No thermostat was available to turn off the heat to control the temperature and the steam generated. One of the two test pans with a heating element failed when the coating fractured from warping of the stainless steel bottom when heated without water in the pan, while curing. This application demonstrated the ability to design a mix for a specific application of a heating element, and also showed the need for a more flexible binder, which will stretch with the thermal expansion of the substrate.

### Example 3

### Vending Machine Water Heater

A coating was compounded from the following ingredients:

TABLE 3

| Ingredient | Amount (g) |
|---|---|
| Graphite 2935K pigment | 60 |
| Printex XE-2 carbon pigment | 20 |
| 850 Flame Control silicone resin | 300 |
| Xylene | 300 |

An inline water tank (designed to hold about a quart of water and be heated to about 195° F. for making hot water of a cup of soup, coffee, or hot chocolate) was coated with the design mix to replace the conventional heating element. In this example, a 3×5 inch area was coated with 5 layers of paint between the leads set 5 inches apart. The system was designed to generate 500 watts of energy at 120 volts and 4.17 amps. The resulting coating had a total resistance of 26 ohms on test sample 1. and 30 ohms on test sample 2. These samples had the thermostatic controls and functions very well with the coating on the outside of the stainless steel container.

### Example 4

### 24′×30′ Flat Grill

A coating was compounded from the following ingredients:

TABLE 4

| Ingredient | Amount (g) |
|---|---|
| Graphite 2935K pigment | 50 |
| Printex XE-2 carbon pigment | 20 |
| 850 Flame Control silicone resin | 300 |
| Xylene | 300 |

A grill was constructed from a 0.5 inch scrap steel plate, 24 inches×30 inches, by first coating the steel with three costs of appliance white powered coating, then placing two sets of 0.5 inch copper leads, 9.5 inches apart and 28 inches long, on the painted side. The area to be coated was masked off and then the steel was painted with 6 coats of the design mix to yield a total resistance on each side of 8 ohms. The coating was cured by heating with 120 volts through a thermostatic control used on typical grills. The coating temperature was slowly raised to 350° F. over three days to avoid any blistering of the coating as the solvent was driven out. The resulting resistance was lower that 8 ohms, so it was sanded to increase the resistance to the 8 ohms design. The grill was maintained at 350° F. for two days and then coated with a clear binder to act as an electrically non-conductive coating. The soldered leads were coated with a non-conductive gasket calk to avoid curling of the copper leads. The whole system then was run for another 3 days at 350° F. for a total of about 50 hours before further testing.

The grill produced 1800 watts per side, or about 667 watts per square foot, i.e., about one-third the energy of a heavy-duty commercial grill. The grill heated up from the ambient temperature to 350° F. in about 22 minutes.

1. A coating composition effective in emitting heat without breaking down when connected to a source of electricity, which comprises:
(a) a binder;
(b) amorphous carbon of particle size between about 0.001 and less than 1 micron;
(c) elemental graphite of particle size between about 0.001 and less than 1 micron; and
(d) a volatile solvent;
wherein the weight amount of (b) and (c) together ranges from between about 5 weight-% and about 80 weight-% based on the non-volatile solids content of the coating composition.

2. The coating composition of claim 1, wherein each of said carbon (b) and said graphite (c) is present in an amount of at least about 1 wt-%.

3. The coating composition of claim 1, wherein said binder is one or more of an acrylic, an alkyd, a cellulosic, an epoxy, a fluoro-plastic, an ionomer, a natural rubber, a nylon, a phenolic, a polyamide, a polybutadiene, a polyester, a polyimide, a polypropylene, a polyurethane, a silicone resin, a silicone natural rubber, a styrene-butadiene; a nitrile rubber, a polysulphide rubber, a vinyl-ethylene, a polyvinyl acetate, a silicate or polysilicate; a hydraulic setting Portland cement, a sodium aluminate or gypsum (Plaster of Paris); a glass; a ceramic; refractory composition; or mineral.

4. A dried film of the coating composition of claim 1, which is substantially devoid of said solvent.

5. A dried film of the coating composition of claim 2, which is substantially devoid of said solvent.

6. A dried film of the coating composition of claim 3, which is substantially devoid of said solvent.

7. A method for generating heat, which comprises:
(a) forming a dried film on a substrate from a non-metallic coating composition, which comprises:
(1) a binder;
(2) amorphous carbon of particle size between about 0.001 and less than 1 micron;
(3) elemental graphite of particle size between about 0.001 and less than 1 micron;
(4) a volatile solvent;
wherein the weight amount of (2) and (3) together ranges from between about 5 weight-% and about 80 weight-% based on the non-volatile solids content of the coating composition;
(b) attaching electrodes to said dried film;
(c) connecting said electrodes to a source of electricity; and
(d) energizing said source of electricity.

8. The method of claim 7, wherein said dried film is formed from a coating composition in which the weight amount of (b) and (c) together ranges from between about 5 weight-% and about 80 weight-% based on the non-volatile solids content of the coating composition.

9. The method of claim 7, wherein said dried film is formed from a coating composition wherein said binder is one or more of an acrylic, an alkyd, a cellulosic, an epoxy, a fluoro-plastic, an ionomer, a natural rubber, a nylon, a phenolic, a polyamide, a polybutadiene, a polyester, a polyimide, a polypropylene, a polyurethane, a silicone resin, a silicone natural rubber, a styrene-butadiene, a nitrile rubber, a polysulphide rubber, a vinyl-ethylene, a polyvinyl acetate, a silicate or polysilicate; a hydraulic setting Portland cement, a sodium aluminate or gypsum (Plaster of Paris); a glass composition; a ceramic; refractory composition; or mineral.

10. An electrically conductive coating effective as one or more of a ground plane or electromagnetic radiation shield without breaking down when exposed to electromagnetic radiation, which comprises:
(a) a binder;
(b) amorphous carbon of particle size between about 0.001 and less than 1 micron;
(c) elemental graphite of particle size between about 0.001 and less than 1 micron; and
(d) a volatile solvent;
wherein the weight amount of (b) and (c) together ranges from between about 5 weight-% and about 80 weight-% based on the non-volatile solids content of the coating composition.

11. The electrically conductive coating composition of claim 10, wherein each of said amorphous carbon (b) and said elemental graphite (c) is present in an amount of at least about 1 wt-%.

12. The electrically conductive coating composition of claim 10, wherein said binder is one or more of an acrylic, an alkyd, a cellulosic, an epoxy, a fluoro-plastic, an ionomer, a natural rubber, a. nylon, a phenolic, a polyamide, a polybutadiene, a polyester, a polyimide, a polypropylene, a polyurethane, a silicone resin, a silicone natural rubber, a styrene-butadiene; a nitrile rubber, a polysulphide rubber, a vinyl-ethylene, a polyvinyl acetate, a silicate or polysilicate; a hydraulic setting Portland cement, a sodium aluminate or gypsum (Plaster of Paris); a glass composition; a ceramic or refractory composition; or mineral.

13. A method for grounding, which comprises:
(a) forming a dried film on a substrate from a non-metallic coating composition, which comprises:
(1) a binder;
(2) amorphous carbon of particle size between about 0.001 and less than 1 micron;
(3) elemental graphite of particle size between about 0.001 and less than 1 micron;
(4) a volatile solvent;
wherein the weight amount of (2) and (3) together ranges from between about 5 weight-% and about 80 weight-% based on the non-volatile solids content of the coating composition,
(b) attaching electrodes to said dried film; and
(c) connecting said electrodes to an electrical ground.

14. The method of claim 13, wherein said dried film is formed from a coating composition wherein said binder is one or more of an acrylic, an alkyd, a cellulosic, an epoxy, a fluoro-plastic, an ionomer, a natural rubber, a nylon, a phenolic, a polyamide, a polybutadiene, a polyester, a polyimide, a polypropylene, a polyurethane, a silicone resin, a silicone natural rubber, a styrene-butadiene; a nitrile rubber, a polysulphide rubber, a vinyl-ethylene, a polyvinyl acetate, a silicate or polysilicate; a hydraulic setting Portland cement, a sodium aluminate or gypsum (Plaster of Paris); a glass composition; a ceramic, refractory composition; or mineral.
